(19) United States
(12) Patent Application Publication
(10) Pub. No.: US 2008/0284606 A1
(43) Pub. Date: Nov. 20, 2008

(54) RADIO FREQUENCY IDENTIFICATION TAG APPARATUS

(75) Inventors: Xiaowei LIU, Beijing (CN); Bo ZHOU, Beijing (CN)

Correspondence Address: SUGHRUE MION, PLLC, 2100 PENNSYLVANIA AVENUE, N.W., SUITE 800, WASHINGTON, DC, 20037, US

(73) Assignee: NEC (CHINA) CO., LTD., Beijing (CN)

(21) Appl. No.: 12/119,847

(22) Filed: May 13, 2008

(30) Foreign Application Priority Data
May 14, 2007 (CN) 200710106227.4

(51) Int. Cl. G08B 13/14

(52) U.S. Cl. 340/572.7

(57) ABSTRACT

The invention provides a physical-characteristic-based RFID tag apparatus which is easy to implement, controllable by a user and capable of enabling privacy protection function as appropriate. According to the invention, there is provided an RFID tag apparatus, comprising: an RFID tag which comprises an antenna and a chip; and a shielding part which is capable of switching between a first state in which it blocks RF signals to or from the RFID tag and a second state in which it does not block RF signals to or from the RFID tag.

### FIELD OF THE INVENTION

The invention generally relates to Radio Frequency Identification (RFID) tag apparatus, and more particularly, to an RFID tag apparatus with a privacy protection function.

### BACKGROUND OF THE INVENTION

RFID enables identification and communication between an object and an information system and between objects. Currently, electronic identity cards based on RFID, electronic passports based on RFID, and Electronic Product Code (EPC) systems based on RFID have been developed and implemented, which bring convenience to production, logistics, sale, utilization and maintenance of products as well as travel of people, and also improve the efficiency of individual identity management by the government. With the development and pervasion of RFID, privacy and security of information has become a matter of concern while benefits from RFID are enjoyed.

Some countries have been using RFID in passports. These passports typically have an RFID tag including a chip and an antenna installed therein. However, the attendant problem is that a malefactor holding an RFID reader within the readable range of the RFID tag can easily read the private information contained in the chip of the RFID tag. Accordingly, a reliable means is needed to protect the privacy of the user in this case.

In China, second generation electronic identity cards based on RFID have been applied throughout the country. The current management approach is to arrange a secure chip at the RFID reader side to ensure the communication between an electronic identity card and the reader. However, such an arrangement substantially limits the application of electronic identity cards in various industries. Predictably, electronic identity cards will be pervasively applied in various industries in the near future. However, how to protect personal privacy will become a common issue of society.

Large chain supermarkets such as Walmart have attached RFID tags comforting to EPC standard to most of the merchandises in logistics and supermarkets, to improve the efficiency of their sale and logistics. After purchasing a product, the customer can destroy (KILL) the RFID tag so that it cannot be read any more. The advantage of this is the customer is ensured that his privacy will not be leaked, while the drawback thereof is the application of RFID cannot be extended during subsequent stages such as customized utilization, maintenance and recall. It can be predicted that RFID will have an in-depth application during post-sale stages of products. Therefore, protecting the privacy of an object per se is also a practical problem.

Currently, privacy protection methods for RFID systems include software protection and physical protection. One scheme is to use a KILL switch to protect an RFID tag. This scheme is further divided into two situations. One is software protection, i.e. built-in KILL command. The command can be issued by the reader. The tag won't respond to any instructions any more after executing the command, and the lifecycle of the tag thus terminates. The other situation is physical protection, i.e. physically destroying the antenna of the tag to prevent the tag from replying information.

Another scheme uses a tag with a block function. Such a scheme prevents the reader from reading information in the tag by electromagnetic interference. When a plurality of tags are placed together and a command is issued by the reader, only those with block function will respond, and others will not.

A further scheme is a tag with a variable reading distance. That is, the physical range in which the tag can make a response is changed using the characteristics and size of the tag antenna, so as to protect privacy.

A still further scheme is an algorithmic tag. That is, the un-authorized information is prevented from replication using computing capabilities and cryptogrammic algorithms within the tag.

Among these solutions, tags utilizing physical characteristics are relatively easy to implement. However, current solutions for physical protection RFID tags do have drawbacks. The problems in the prior art will be explained below using a Clipped tag from IBM corporate as an example. The principle of the clipped tag from IBM is shown in FIG. 1. As shown in FIG. 1, the IBM clipped tag 10 includes an antenna 11, a chip 12, a substrate 13 and scrapable material 14. With the clipped tag designed by IBM, a user can change the antenna connection to enable a physical damage of the antenna, so as to protect privacy. An advantage thereof is that the contents in the chip are physically isolated from being read, while a disadvantage is that the tag cannot be reused.

In view of the foregoing, there is a need for a physical-characteristic-based RFID tag apparatus which is easy to implement, controllable by a user and capable of enabling privacy protection function as appropriate.

### SUMMARY OF THE INVENTION

An object of the invention is to provide a physical-characteristic-based RFID tag apparatus which is easy to implement, controllable by a user and capable of enabling privacy protection function as appropriate.

According to the invention, there is provided an RFID tag apparatus, comprising: an RFID tag which comprises an antenna and a chip; and a shielding part which is capable of switching between a first state in which it blocks Radio Frequency signals (RE signals) to or from the RFID tag and a second state in which it does not block RF signals to or from the RFID tag.

The invention has a number of advantages, including: 1) it is very easy to implement—any companies having basic chip packaging capability can implement the invention; 2) the privacy protection function can be easily controlled by a user; 3) the reuse of the privacy protection function may be ensured without affecting any performances or functions of the tag; 4) privacy can be perfectly protected—it can be reliably ensured that privacy cannot be read as RF signals are blocked and communication between the tag and the reader is cut off; and 5) various ways of application exist including not only privacy protection for personal information in electronic identity cards, electronic passports, or the like, but also privacy protection for products.

### DESCRIPTION OF THE DRAWINGS

The above and other features and advantages of the invention can be better understood by reading the detailed description below in connection with the drawings. In the drawings, same or similar reference signs are used to designate same or similar elements, in which:

FIG. 1 shows the principle of a physical protection type tag in the prior art.

FIG. 2 shows the principle of an RFID tag apparatus according to the invention.

FIGS. 3A-3F show RFID tag apparatuses according to a first to a sixth embodiment of the invention.

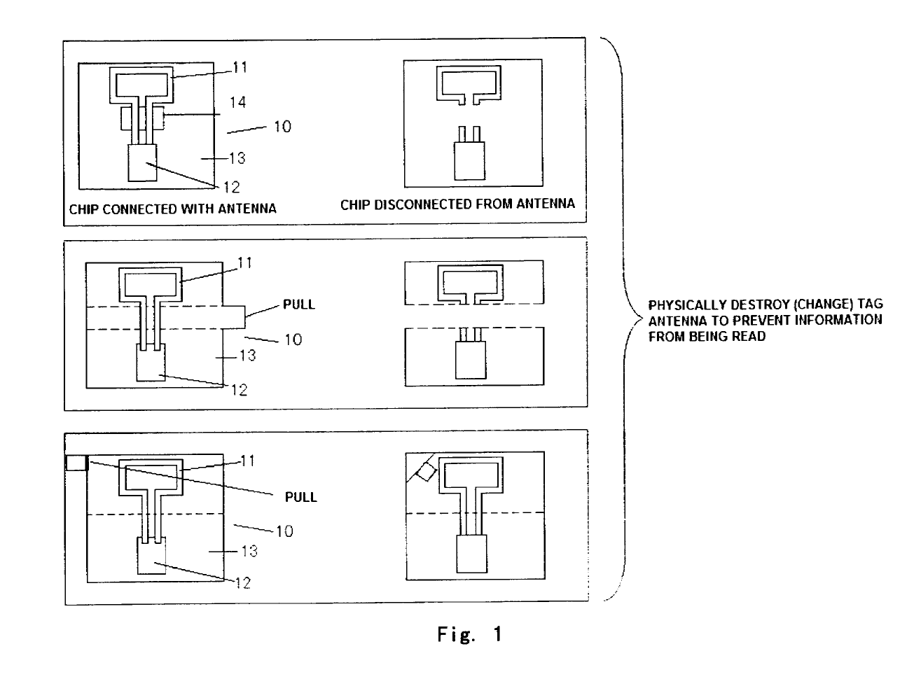

### DETAILED DESCRIPTION

Hereafter, the principle and implementation of the invention will be explained in detail with reference to the figures.

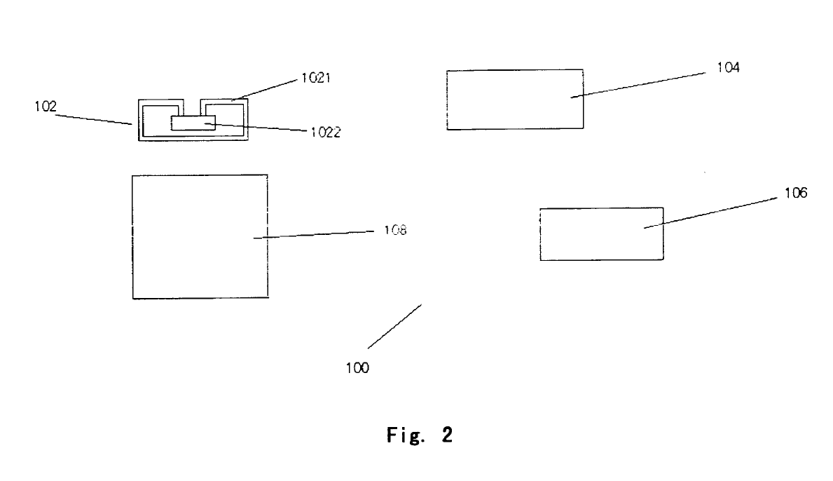

The principle of the invention is shown in FIG. 2. As shown in the figure, an RFID tag apparatus 100 of the invention includes an RFID tag 102 with an antenna 1021 and a chip 1022, a shielding part 104 for blocking RF signals, a film 106 and a substrate 108 for mounting the above components. In embodiments of the invention, the shielding part 104 can be a printable metal sheet or metal film, for example, an aluminum sheet or aluminum film. Based on the principle of Faraday cage, the mental sheet or mental film 104 for shielding is arranged between the tag 102 and a reader (not shown), in particular, between the antenna 1021 of the tag and the reader, to enable physical isolation of RF signals, so that information in the tag 102 cannot be read. The substrate 108 is typically made of plastic for attaching to an object to which the RFID tag apparatus 100 is to be attached. The film 106 may be used to protect the tag 102 to prevent the tag 102 from being damaged when the mental sheet or mental film 104 is removed.

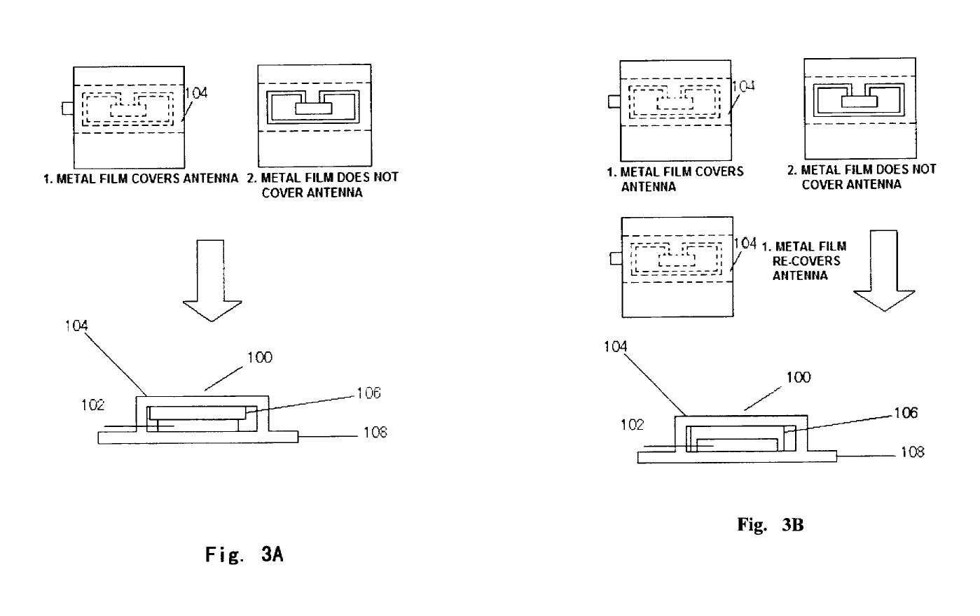

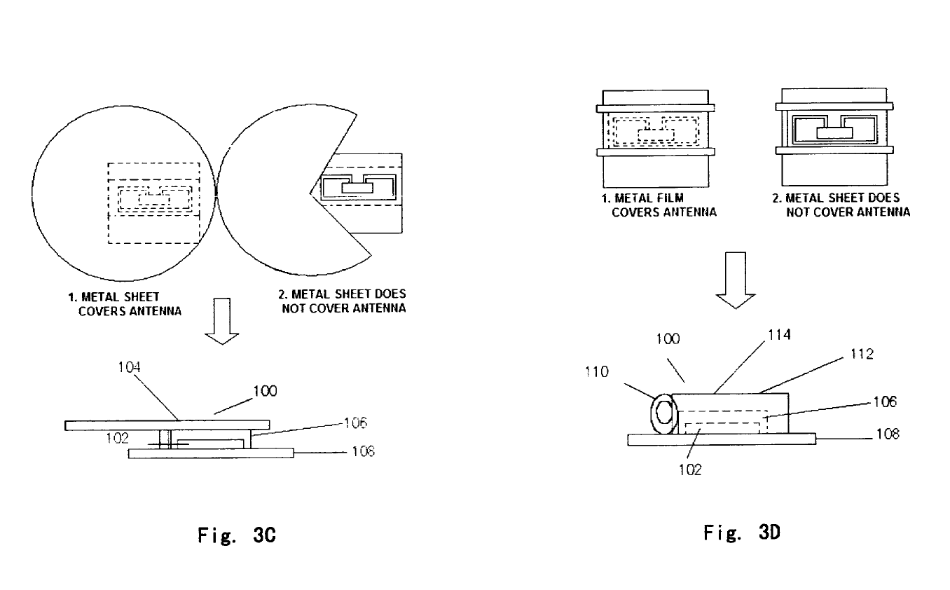

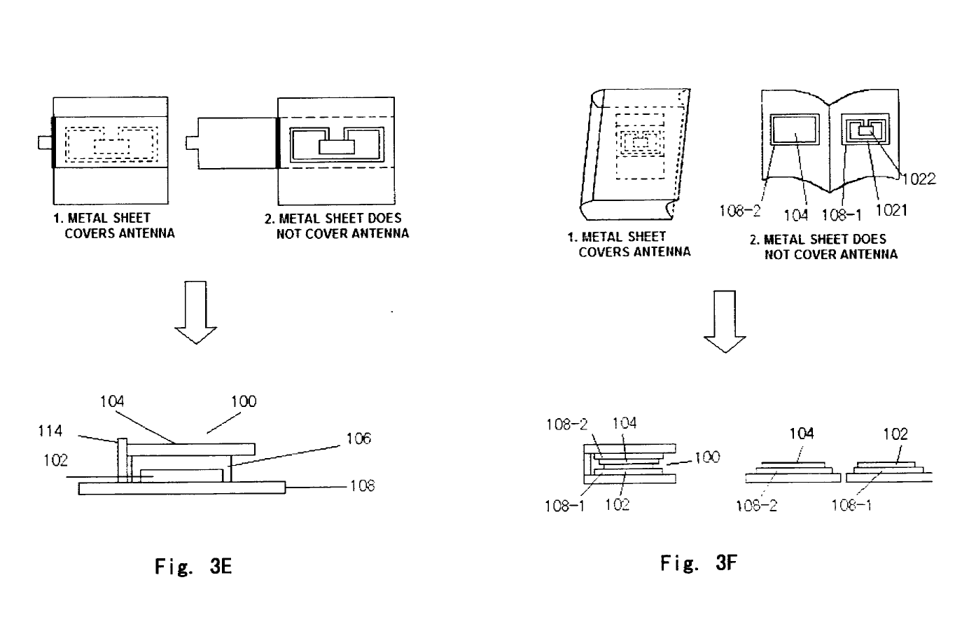

The RFID tag apparatuses according to the respective embodiments of the invention are described below in detailed with reference to FIGS. 3A-3F.

FIG. 3A shows an RFID tag apparatus according to a first embodiment of the invention. As shown in FIG. 3A, an RFID tag apparatus 100 includes an RFID tag 102, a metal film 104, a plastic film 106 and a substrate 108. The substrate 108 is attached to an object to which the RFID tag apparatus 100 is to be attached. The tag 102 is attached to the substrate 108. The tag 102 is covered by the plastic film 106 to prevent the tag 102 from being damaged when mental film 104 is stripped off. The mental film 104 is attached to the plastic film 106 such that the mental film 104 completely covers the tag 102, or at least completely covers the antenna 1021 of the tag 102. Meanwhile, the mental film 104 is attached to the substrate 108, with densely and regularly patterned holes at the attaching edges to facilitate stripping. After being stripped off, the mental film 104 cannot be attached any more.

As shown in the upper part of FIG. 3A, in state 1 in which the mental film 104 at least covers the antenna 1021 of the tag 102, RF signals to and/or from the tag 102 are blocked, and the information in the tag cannot be read. When a user decides to read the information contained in the chip 1022 of the tag 102, for the purpose of anti-counterfeit authentication, for example, the user may strip off the mental film 104 to expose the antenna 1021, thereby communication can be carried out between the reader and the tag, and the information in the tag can be read (state 2).

In the first embodiment, as the plastic film 106 is stuck with the mental film 104 instead of with the tag, the plastic film 106 will be removed as well when the mental film 104 is stripped off, and the usage of the tag 102 will not be affected. However, It can be seen that in this case the shielding part 104 (mental film) can be used only once, and cannot be re-attached to the tag for shielding once it is stripped off.

FIG. 3B shows an RFID tag apparatus according to a second embodiment of the invention. As shown in FIG. 3B, an RFID tag apparatus 100 includes an RFID tag 102, a metal film 104, a hard plastic film 106 and a substrate 108. Similarly as in the first embodiment, the substrate 108 is attached to an object to which the RFID tag apparatus 100 is to be attached, and the tag 102 is attached to the substrate 108. What is different from the first embodiment is that the tag 102 is covered by the hard plastic film 106 to prevent the tag 102 from being damaged when the mental film 104 is stripped off, and after the mental film 104 is stripped off, the hard plastic film 106 will not be removed along with it. The mental film 104 is attached to the hard plastic film 106 such that the mental film 104 completely covers the tag 102, or at least completely covers the antenna 1021 of the tag 102. Meanwhile, the mental film 104 is attached to the substrate 108, with densely and regularly patterned holes at the attaching edges to facilitate stripping. Differently from the first embodiment, in the second embodiment, the mental film 104 can be re-attached to the hard plastic film 106 to completely cover the tag 102 or at least completely cover the antenna 1021.

As shown in the upper part of FIG. 3B, in state 1 in which the mental film 104 at least covers the antenna 1021 of the tag 102, RF signals to and/or from the tag 102 are blocked, and the information in the tag cannot be read. When a user decides to read the information contained in the chip 1022 of the tag 102, the user may strip off the mental film 104 to expose the antenna 1021, thereby communication can be carried out between the reader and the tag, and the information in the tag can be read (state 2). In state 2, the plastic film 106 remains on the tag 102, and the adhesive between the plastic film 106 and the mental film 14 keeps its adhesiveness.

When later the user again wants to protect privacy, he may re-attach the mental film 104 to the hard plastic film 106 so as to block RF signals to and/or from the tag 102 again. It can be seen that according to the second embodiment, the shielding function of the shielding part 104 (mental film) can be used for a number of times.

FIG. 3C shows an RFID tag apparatus according to a third embodiment of the invention. As shown in FIG. 3C, an RFID tag apparatus 100 includes an RFID tag 102, a metal sheet 104, a hard plastic film 106 and a substrate 108. In the third embodiment of the invention, the metal sheet 104 is a circular metal sheet which has an indentation and is rotatable around its center, and its center is fixed on the substrate 108. The size of the indentation is slightly larger than or equal to the size of the tag 102, or at least slightly larger than or equal to the size of the antenna 1021. Similarly as in the second embodiment, the substrate 108 is attached to an object to which the RFID tag apparatus 100 is to be attached, the tag 102 is attached to the substrate 108, and the tag 102 is covered by the hard plastic film 106 to prevent the tag 102 from being damaged when the mental sheet 104 is rotated.

As shown in the upper part of FIG. 3C, in state 1 in which the metal sheet is rotated to a position at which it covers at least the antenna 1021 of the tag 102, RF signals to and/or from the tag 102 are blocked, and the information in the tag cannot be read. When a user decides to read the information contained in the chip 1022 of the tag 102, the user may rotate the metal sheet 104 to a position at which the position of the indentation thereof and the position of the antenna 1021 correspond to each other so that the antenna 1021 is exposed, thereby communication can be carried out between the reader and the tag, and the information in the tag can be read (state 2). When later it is needed again to protect privacy, the circular metal sheet 104 can be rotated so that it completely covers at least the antenna 1021 to block RE signals to and/or from the tag 102 again. It can be seen that according to the third embodiment, the shielding function of the shielding part 104 (mental sheet) can be utilized for more than one time as well.

FIG. 3D shows an RFID tag apparatus according to a fourth embodiment of the invention. As shown in FIG. 3D, an RFID tag apparatus 100 includes an RFID tag 102, a metal film 104, a hard plastic film 106, a substrate 108 and a roller 110 arranged at one side of the tag 102 for winding the mental film 104. Optionally, the RFID tag apparatus 100 further includes a pair of baffles arranged on two sides of the tag 102 which are perpendicular to the axis of the roller 110, for confining the position of the mental film 104 relative to the tag when it is extended. Similarly as in the second and third embodiments, the substrate 108 is attached to an object to which the RFID tag apparatus 100 is to be attached, the tag 102 is attached to the substrate 108, and the tag 102 is covered by the hard plastic film 106 to prevent the tag 102 from being damaged when the mental film 104 is extended or wound.

As shown in the upper part of FIG. 3D, in state 1 in which the mental film 104 is extended to cover at least the antenna 1021 of the tag 102, RF signals to and/or from the tag 102 are blocked, and the information in the tag cannot be read. When a user decides to read the information contained in the chip 1022 of the tag 102, he may rotate the roller 110 so that the mental film 104 is wound around the roller 110 so as to expose the antenna 1021, thereby communication can be carried out between the reader and the tag, and the information in the tag can be read (state 2). When later it is needed again to protect privacy, the mental film 104 may be extended again so that it completely covers at least the antenna 1021 to block RF signals to and/or from the tag 102 again. It can be seen that according to the fourth embodiment, the shielding function of the shielding part 104 (mental film) can also be utilized for multiple times.

FIG. 3E shows an RFID tag apparatus according to a fifth embodiment of the invention. As shown in FIG. 3E, an RFID tag apparatus 100 includes an RFID tag 102, a metal sheet 104, a hard plastic film 106, a substrate 108 and a doorframe-like baffle 104 for confining the position of the metal sheet 104 relative to the tag 102 when the metal sheet 104 is pushed or pulled. Similarly as in the second, third and fourth embodiments, the substrate 108 is attached to an object to which the RFID tag apparatus 100 is to be attached, the tag 102 is attached to the substrate 108, and the tag 102 is covered by the hard plastic film 106 to prevent the tag 102 from being damaged when the metal sheet 104 is pushed or pulled.

As shown in the upper part of FIG. 3E, in state 1 in which the mental sheet is pulled to a position at which it covers at least the antenna 1021 of the tag 102, RF signals to and/or from the tag 102 are blocked, and the information in the tag cannot be read. When a user decides to read the information contained in the chip 1022 of the tag 102, he may push the metal sheet 104 to a position at which the antenna 1021 is exposed, thereby communication can be carried out between the reader and the tag, and the information in the tag can be read (state 2). When later it is needed again to protect privacy, the mental film 104 may be pulled again so that it completely covers at least the antenna 1021 to block RF signals to and/or from the tag 102 again. It can be seen that according to the fifth embodiment, the shielding function of the shielding part 104 (mental sheet) can also be utilized for multiple times.

FIG. 3F shows an RFID tag apparatus according to a sixth embodiment of the invention. As shown in FIG. 3F, an RFID tag apparatus 100 includes an RFID tag 102, a metal sheet 104, and substrates 108-1 to 108-2. The RFID tag apparatus according to the sixth embodiment is mainly applicable to book-like objects that can be switched between a close state and an open state, such as passports, books, electronic purses, or the like. The sixth embodiment will be explained below using application in a passport as an example. As shown in FIG. 3F, the substrate 108-1 is attached to a page of the passport, and the tag 102 is attached to the substrate 108-1. Similarly as in the second, third, fourth, and fifth embodiments above, the tag 102 is covered by a hard plastic film 106 to prevent the tag 102 from being damaged due to friction.

The substrate 108-2 is attached to another page of the passport, and the metal sheet 104 is attached to the substrate 108-2. The position of the substrates 108-1 and 108-2 is such that when the passport is closed, the metal sheet 104 can cover the tag 102, or at least cover the antenna 1021 of the tag 102.

As shown in the upper part of FIG. 3F, in state 1 in which the passport is closed such that the metal sheet 104 covers at least the antenna 1021 of the tag 102, RF signals to and/or from the tag 102 are blocked, and the information in the tag cannot be read. On the other hand, in state 2, i.e., when a user decides to read the information contained in the chip 1022 of the tag 102, he may simply open the passport to expose the antenna 1021, thereby communication can be carried out between the reader and the tag, and the information in the tag can be read. Apparently, switching between the state in which RF signals to and/or from the tag 102 are blocked and the state in which RF signals to and/or from the tag 102 are not blocked can be easily performed by opening or closing the passport. Therefore, according to the sixth embodiment, the shielding function of the shielding part 104 (mental sheet) can also be utilized for multiple times.

Some embodiments of the invention have been described above with reference to the drawings. However, those skilled in the art may readily appreciate other modifications and alternatives in light of the teaching of the invention.

For example, in the above embodiments, the shielding part is a printable metal sheet or a mental film. However, the invention is not so limited. The shielding material may not be metal, as long as it can block RF signals. For example, water can also block high frequency electromagnetic waves. In addition, the metal sheet or mental film may not be attached by printing, as long as in a certain state it can cover above the tag.

In addition, in the above embodiments, a substrate is used to attach the tag and so on to an object. However, the substrate may not be necessary, and the tag can be directly attached to the object.

Furthermore, in the above embodiments, a film is arranged for protecting the tag, and is preferably made of plastic or hard plastic. Apparently, the film may be made of other materials capable of protecting the tag. In addition, the film may not be necessary.

1. A Radio Frequency Identification (RFID) tag apparatus, comprising:
an RFID tag which comprises an antenna and a chip; and
a shielding part which is capable of switching between a first state in which it blocks Radio Frequency signals (RF signals) to or from the RFID tag and a second state in which it does not block RF signals to or from the RFID tag.

2. The RFID tag apparatus according to claim 1, wherein the shielding part is made of metal.

3. The RFID tag apparatus according to claim 2, wherein the shielding part is a metal sheet or a metal film which covers at least the antenna while in the first state and does not cover the antenna while in the second state.

4. The RFID tag apparatus according to claim 3, wherein the shielding part is directly or indirectly attached on the RFID tag to cover at least the antenna while in the first state and is detached from the RFID tag so as not to cover the antenna while in the second state, and is capable of switching between the first state and the second state for at least once.

5. The RFID tag apparatus according to claim 3, wherein the shielding part is a circular metal sheet having an indentation and rotatable around its center, the position of the center of the circular metal sheet being fixed relative to the RFID tag, the size of the indentation being corresponding to the size of the antenna, and wherein the shielding part is rotated to a position at which it covers at least the antenna while in the first state, and is rotated to a position at which the position of the indentation and the position of the antenna correspond to each other so that the antenna is not covered while in the second state.

6. The RFID tag apparatus according to claim 3, further comprising:
a roller provided at one side of the RFID tag for winding the shielding part, and wherein
the shielding part is extended to cover at least the antenna while in the first state, and is wound around the roller so as not to cover antenna while in the second state.

7. The RFID tag apparatus according to claim 3, wherein the shielding part is a metal sheet, and the RFID tag apparatus further comprises a doorframe-like baffle for confining the position of the shielding part relative to the RFID tag when the shielding part is pushed or pulled, and wherein
the shielding part is pushed to a position at which it covers at least the antenna while in the first state, and is pulled to a position at which it does not cover the antenna while in the second state.

8. The RFID tag apparatus according to claim 3, wherein the RFID tag is attached on a first portion of a product including at least the first portion and a second portion whose relative position can be changed, and the shielding part is attached on the second portion, and wherein the first state of the shielding part is obtained by changing the relative position of the first portion and the second portion so that the shielding part covers at least the antenna, and the second state of the shielding part is obtained by changing the relative position of the first portion and the second portion so that the shielding part does not cover the antenna.

9. The RFID tag apparatus according to any of claims 4-8, further comprising a tag protecting part for preventing the RFID tag from being damaged while the shielding part is switching between the first state and the second state.

10. The RFID tag apparatus according to claim 9, wherein the tag protecting part is a hard plastic film which remains covering the RFID tag while the shielding part is switching between the first state and the second state.

11. The RFID tag apparatus according to claim 1, further comprising a substrate, and wherein the RFID tag is attached on the substrate.
